(19) United States
(12) Patent Application Publication
(10) Pub. No.: US 2001/0016871 A1
(43) Pub. Date: Aug. 23, 2001

(54) Distributed processing system and clients

(75) Inventor: Shigeru Fujita, Kawasaki (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: FUJITSU LIMITED

(21) Appl. No.: 09/785,175

(22) Filed: Feb. 20, 2001

(30) Foreign Application Priority Data
Feb. 18, 2000 (JP) 2000-041111

(51) Int. Cl. G06F 15/16; G06F 17/60

(52) U.S. Cl. 709/203; 705/16; 709/201

(57) ABSTRACT

The present invention provides a distributed processing system that eliminates the need for server clustering technology and will not pose a problem that the overall system would go down when the server fails, and clients for use in said system.

Of a plurality of POS clients 10a, 10b, 10c, . . . , and 11a, 11b, 11c, and so forth that are linked in series to form a system, fat clients 10a and 10b have server functionality so that they execute processing in response to requests issued from thin clients 10b, 10c, . . . , 11b, 11c, and so forth and output the processing results to said thin clients that issued such requests, and they are capable of standalone operation.

### FIELD OF THE INVENTION

The present invention relates to a distributed processing system that executes distributed processing by use of a plurality of processing devices, such as computers, and clients for use in said system.

### DESCRIPTION OF THE PRIOR ART

With a prior art distributed processing system comprised of clients and a server, an application resides on the client side; thus, any modification or correction to such an application must be made for all the clients, resulting in increased administrative costs. The presence of an application on the client side means that all the clients must be equipped with a hard disk; additionally, as the application becomes bloated over years, the client hardware accordingly demands an increasingly high level of performance.

Against that background, a client/server system based on a thin client scheme has been employed recently. By a “thin client”, it generally means a client with capability such that it causes the server-side application to perform necessary processing and merely receives the processing result for display; thus, its program size can be minimized, which eliminates the need for hard disk and other disks, so that the thin client is often configured in disk-less architecture. And the thin client offers the following advantages over the prior art configuration:

1) Because an application resides and runs on the server side, modifications or correction to the application can be made easily, thus resulting in reduced administrative costs; and

2) Because the application runs on the server side, the hardware of the client can be simplified, which can reduce costs accordingly (because the thin client does not require a high level of performance, its cost can be minimized). Therefore, the system cost can be reduced for a system that involves a large number of clients.

Such a client/server system configuration is often based on a World Wide Web platform. The World Wide Web is a system for implementing delivery of information (home pages, etc.) over the Internet, and its system configuration comprises one or more web servers (server machines) 21 that deliver information, and a plurality of clients 16 that have a browser 12 and request information, as shown in FIG. 6.

A flow of information delivery in such a system configuration is typically implemented by a mechanism wherein, in response to a request from the browser 12, the web server 21 forwards the information (HTML (HyperText Markup Language) documents, etc.) requested by the client 16 to that browser 12 via HTTP protocol (HyperText Transfer Protocol) communication, and the resulting information is displayed on the screen of that browser 12.

Such a client/server system configuration is applied to a POS system and reduces TCO (Total Cost of Ownership) for the reasons 1) and 2) above.

However, with the client/server system configuration based on the World Wide Web platform, control is heavily dependent upon the server; thus, if the server goes down, the communication is disconnected, and the processing by use of a client cannot be performed at all. Of course, neither the failure of the server and disconnected communication is restricted to the World Wide Web platform, and no processing can be done on the client side.

As a solution to the failure of the server, server clustering technology has been considered. FIG. 7 shows one such clustering configuration. As shown, server clustering not only requires additional server 21 to be installed, but also must provide a shared disk 22 so that information is always shared among a plurality of web servers 21. This complicates the system architecture and results in increased administrative costs and hardware purchase costs. Especially for a POS system, because the user is highly cost-conscious and is placing a high demand for as low system/machine costs as possible, an inexpensive system configuration is demanded, and a POS system may not be adopted for this reason.

### SUMMARY OF THE INVENTION

An object of the present invention is to provide a distributed processing system that even when the server goes down, the overall system will not be brought down together (in other words, a client will not be able to receive the result of application processing), and clients for used in such a system.

Thus, a distributed processing system according to the present invention comprises a plurality of clients linked in series, wherein at least one of said clients is operable in standalone fashion and has server functionality so that it executes processing in response to requests issued by other clients and outputs the results of the processing to said clients that issued such requests.

So configured, because at least one of the clients linked in series is operable in standalone fashion and has the afore-described server functionality, if an original server (which does not act as a client but as a server that should be originally placed upstream of the client that has the afore-described server functionality) goes down, or if there is no such server at all, the server-capable client operates in standalone fashion and acts for the original server, so that its processing results can always be received on the client side. Thus, according to this configuration, the implementation of an original server (i.e., a server that is placed upstream of the server-capable client) is not necessarily required.

As described above, the server functionality provided on the client side is such that processing is executed in response to requests issued by other clients (an application, etc. is running), and the results of the processing are outputted to said clients that issued such requests; and according to this configuration, said client itself can operate in standalone fashion and provide said server functionality, so that the results of the processing can always be received on the client side, even when an original server goes down or such an original server is absent, as described above.

Claim 2 sets forth processing of a POS application where the configuration of claim 1 is applied to a POS system. More specifically, processing of a POS application in a POS client having the server functionality includes at least one of the following: product registration, product search, transaction aggregation per transaction, tax aggregation per transaction, discount per target product, designation of payment method, settlement, transaction history registration, and operator authentication and registration.

The above processing includes product registration where items to be sold are registered; processing that is executed by the operator via a POS client and is required for each transaction with a customer (product search, transaction aggregation per transaction, tax aggregation per transaction, discount per target product, designation of payment method, and settlement); transaction history registration that is recorded in chronological order or in other ways; operator registration where the right to operate the POS system is provided to the operator; and operator authentication which is required when the operator operates the POS system. These are normally executed by the POS application running on the POS server side as the operator operates on the POS client side; however, according to the present implementation, such processing is executed by the server-capable POS client, in place of the POS server. Of course, the results of the processing are returned to the POS client that issued a request.

Claims 3 and 4 set forth implementations of the distributed processing system of claims 1 and 2, as seen from the client side.

According to claim 3, which corresponds to claim 1, a plurality of clients linked in series, wherein at least one of said clients is operable in standalone fashion and has server functionality so that it executes processing in response to requests issued by other clients and outputs the results of the processing to said clients that issued such requests.

According to claim 4, which corresponds to claim 2, processing of a POS application in a POS client having the server functionality includes at least one of the following:

product registration, product search, transaction aggregation per transaction, tax aggregation per transaction, discount per target product, designation of payment method, settlement, transaction history registration, and operator authentication and registration.

### BRIEF DESCRIPTION OF THE DRAWINGS

FIG. 1 is a schematic diagram depicting one embodiment for implementing the present invention.

FIG. 2 is a schematic diagram for explaining POS clients 10b, 10c, and so forth and 11b, 11c, and so forth according to the present embodiment.

FIG. 3 is a schematic diagram for explaining POS clients 10a and 11a according to the present embodiment.

FIG. 4 is a flowchart illustrating the process flow for POS clients 10b, 10c, and so forth or 11b, 11c, and so forth in the present POS system.

FIG. 5 is a flowchart illustrating the process flow for POS client 10a or 11a in the present POS system.

FIG. 6 is a system schematic diagram for explaining a client/server system based on a World Wide Web platform.

FIG. 7 is a diagram for explaining a server clustering architecture.

### DETAILED DESCRIPTION OF THE PREFERRED EMBODIMENT

An embodiment of the present invention is described below with reference to the drawings.

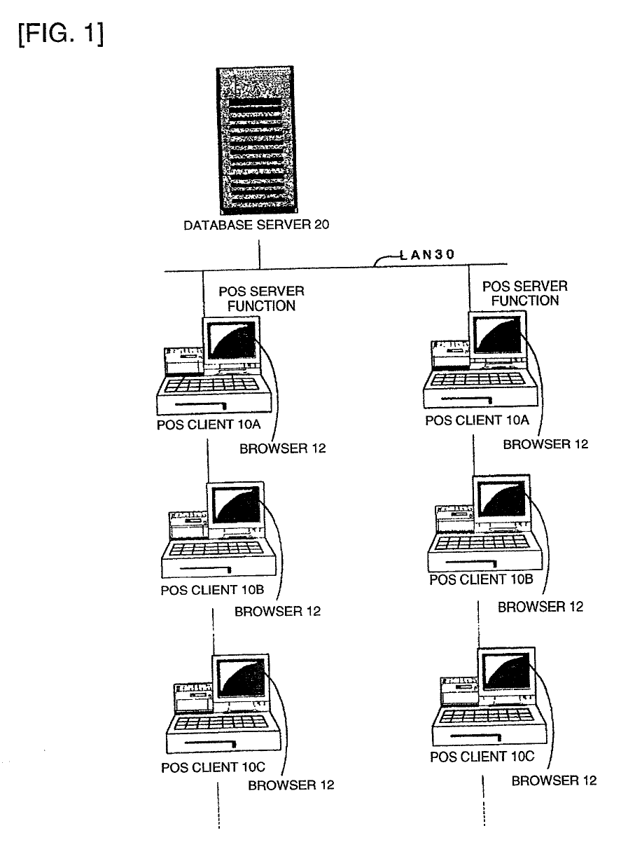

FIGS. 1-3 describe one embodiment for implementing the present invention. According to the present implementation, there is shown one example where the distributed processing system of the present invention is applied to POS system based on a World Wide Web platform.

It should be appreciated that in the present embodiment, the target is a system based on the World Wide Web platform, although the platform itself is not limited thereto, and any system that utilizes a thin client to be described hereinbelow or similar device may be applicable, as a whole.

As shown in the drawings, this POS system is comprised of: a group of POS clients 10a, 10b, 10c, and so forth that are connected via a LAN (Local Area Network) 30; a group of POS clients 11a, 11b, 11c, and so forth that are also connected via the LAN 30; and a database server 20 connected to those POS client groups. It should be appreciated that each of the client groups is shown to have three clients connected, respectively, although more clients may be connected in series within each group as described hereinbelow. Alternatively, the POS clients 10b, 10c, and so forth may be connected in parallel to the POS clients 10a (and the POS clients 11a, 11b, 11c, and so forth may also be connected similarly).

The group of POS clients 10a, 10b, 10c, and so forth and the group of POS clients 11a, 11b, 11c, and so forth are similarly configured, in principle, each having a browser 12; however, the POS client 10a and POS client 11a are operable in standalone fashion and have the web server functionality as described hereinbelow. “Operable in standalone fashion” means that the client executes processing (for example, barcode reading, displaying of product price or total amount, etc.) as a POS client in standalone fashion and also has a built-in POS application 15 as described hereinbelow, so that it can execute the POS application in response to a request from its own browser and return the processing result.

Because of the operability in standalone fashion and the web server functionality, the present POS system eliminates the need for a POS server that would be present in a conventional POS system as a standalone system component, but only has a database server 20 that merely collects transaction history data of all the POS clients and performs aggregation according to the season, chronological order, customer age, product category, and other parameters.

The database server 20 is not an original server that activates an application in response to a request of a client and outputs the processing result to the client that issued the request, but a server that collects transaction history data from the web server-capable POS clients 10a and 11a, as well as from other POS clients, 10b, 10c, . . . , 11b, 11c, and so forth and performs the above-mentioned aggregation. That is, it does not perform processing of POS applications, such as product registration, product search, transaction aggregation per transaction, tax aggregation per transaction, discount per target product, designation of payment method, settlement, transaction history registration, operator authentication and registration, and thus if the database server 20 goes down, it will not affect the processing of the POS clients but merely cease to provide the afore-described aggregate processing.

It should be appreciated that in the hierarchical structure of the POS system according to the present embodiment, the POS clients 10a and 11a (i.e., fat clients to be described hereinafter) are positioned between the database server 20 and the POS clients 10b, 10c, . . . , 11b, 11c, and so forth (i.e., thin clients to be described hereinafter).

In the present embodiment, it is also assumed that the POS clients 10a and 11a (fat clients to be described hereinafter) and other POS clients 10b, 10c, . . . , 11b, 11c, and so forth (thin clients to be described hereinafter) have essentially the same structure; however, if the POS clients 10a and 11a are equipped with the afore-described web server functionality, an inexpensive POS system may be required to have thin clients, or POS clients 10b, 10c, . . . , 11b, 11c, and so forth that provide relatively lower levels of performance than that of fat clients, or POS clients 10a and 11a.

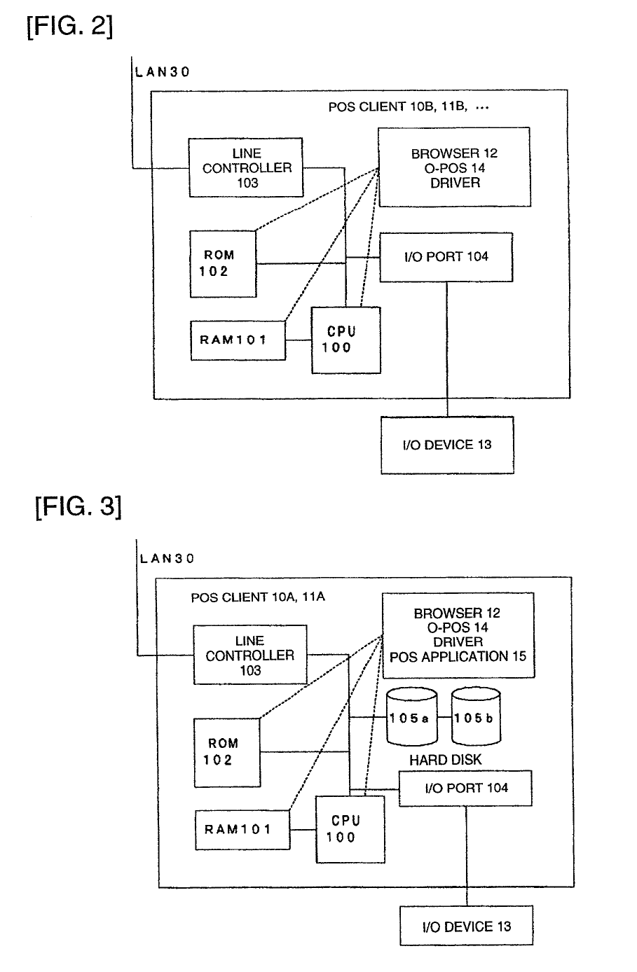

The POS client 10b, 10c, . . . , 11b, 11c, and so forth comprises a CPU 100, a RAM 101, a ROM 102, a line controller 103, and an I/O port 104, as shown in FIG. 2. With the present system, software such as an embedded operating system (OS) for controlling the overall POS client, a browser 12 running on that OS, and O-POS 14 to be described hereinafter, is contained in the ROM 102.

With the POS client 10b, 10c, . . . , 11b, 11c, and so forth, it is not necessary to run any POS application within the POS client, but only the browser 12 may run, so that the code size of the afore-mentioned software is substantially smaller than that of prior art systems, and is small enough to be contained in the ROM 102 as described above. As a result, the POS clients 10b, 10c, . . . , 11b, 11c, and so forth eliminate the need for any internal hard disk. Accordingly, they are hereinafter referred to as “thin clients”. In a typical client/server system, a main culprit of failure on the client side is its hard disk; thus, the system of the present invention provides substantially improved system reliability by eliminating the need for hard disks. Additionally, because the thin clients 10b, 10c, . . . , 11b, 11c, and so forth do not perform any data processing themselves, as described above, the CPU 100 itself included as their component does not require a high level of performance, so that an inexpensive system configuration can be implemented.

On the other hand, the POS clients 10a and 11a have, in principle, essentially the same configuration as the thin clients 10b, 10c, . . . , 11b, 11c, and so forth (i.e., CPU 100, RAM 101, ROM 102, line controller 103, and I/O port 104). In addition, they contain hard disks 105a and 105b. The dual hard disks 105a and 105b contain similar software as described above, as well as a POS application 15 as embedded software. The software or data stored therein is mirrored between the two drives (it should be appreciated that this mirroring is not essentially, although it is prefarable for actual operation).

Because the POS clients 10a and 11a are configured as described above, and because they have the server functionality so that a POS application is activated in response to requests issued by other POS clients and the processing results are output to the POS clients that issued such requests, and furthermore because they are operable in standalone fashion, the POS clients 10a and 11a are referred to as “fat clients” in contrast to other POS clients 10b, 10c, . . . , 11b, 11c, and so forth called “thin clients” that lack such functionality.

The number of thin clients 10b, 10c, . . . , 11b, 11c, and so forth that can be connected is determined by the performance of the fat clients 10a and 11a (“. . . ” and “and so forth” used herein and in the drawings indicate that there are a plurality of clients); the more the thin clients that can be connected, the lower the cost of the overall system; conversely, a higher level of performance is demanded for the fat clients, resulting in higher costs to be incurred. Thus, factors such as the performance of fat clients, the number of clients that comprise the system, overall scale of the system, and price will determine the number of thin clients that are connected to the fat clients. As described above, the CPU 100 of the thin clients 10b, 10c, . . . , 10b, 11c, and so forth does not demand a high level of performance, whereas the CPU 100 of the fat clients 10a and 11a desirably provides a relatively higher level of performance because it is required to execute various types of data processing in response to requests issued by the thin clients 10b, 10c, . . . , 11b, 11c, and so forth.

The fat clients 10a and 11a and thin clients 10b, 10c, 11b, 11c, and so forth include, as I/O devices 13 interfaced to the I/O port 104, a barcode reader for reading the barcode; a customer display for providing necessary indications to the customer and the operator of the POS client; a journal/receipt printer for recording the transaction history and printing out the cash-register receipt for the customer; and a cash-register drawer for paying and receiving money.

In the present implementation, each client has a POS OS 14 (OLE for Retail POS, or O-POS) for controlling these I/O devices 13 and accepting events of the I/O devices 13 The O-POS 14 controls the I/O devices 13, accepts events of the I/O devices 13, and provides input/output to and from the browser 12 in response thereto.

The browser 12 makes a request for necessary information, via a remote procedure call, or RPC, to the POS application 15 installed in the fat clients 10a and 11a that offers the web server functionality, and the processing results of the POS application 15 are returned to the browser 12 in the form of DHTML (Dynamic HyperText Markup Language) or the like via HTTP protocol communication from the web server-capable fat clients 10a and 11a to the thin clients 10b, 10c, . . . , 11b, 11c, and so forth. On the thin clients 10b, 10c, . . . , 11b, 11c, and so forth, the browser 12 displays the processing results as needed.

Because the fat clients 10a and 11a are operable in standalone fashion, the browser 12 installed therein makes a direct request for necessary information to its own POS application 15, and the processing results are returned from the POS application 15 to the browser 12 in the form of DHTML or the like. On the fat clients 10a and 11a, the browser 12 displays the processing results as needed.

Of the POS clients, the server-capable fat clients 10a and 11a accept input/output based on events of the I/O devices 13 from their own browser 12 or the browser 12 of other thin clients 10b, 10c, . . . , 11b, 11c, and so forth, and the POS application is activated in response thereto, so that its processing result is returned to the fat client 10a or 11a or the thin clients 10b, 10c, and so forth or 11b, 11c, and so forth that issued such a request.

For example, when a product registration is performed on the present POS system, it is processed as follows. First, the barcode is scanned by the barcode reader of the fat client 10a and 11a or thin client 10b, 10c, . . . , 11b, 11c, and so forth. Then, an event of the barcode reader is inputted to the browser 12 via the O-POS 14 of the fat client 10a and 11a or thin client 10b, 10c, . . . , 11b, 11c, and so forth. The browser 12 makes a request for necessary product search and presentation of the search result to the POS application 15 installed in the web server-capable fat client 10a or 11a. The fat client 10a and 11a has a product registration PLU (Price Look Up) file that stores information, such as product names and unit prices, corresponding to product codes for product identification, and the POS application 15 is responsive to this request to perform product search by use of this PLU file. That is, the product code scanned from the barcode is transferred from the thin client 10b, 10c, . . . , 11b, 11c, and so forth to the fat client 10a and 11a, and the fat client 10a and 11a searches through the PLU file in response thereto. The product name, unit price, and the like obtained by the search are returned to the browser 12 in the form of DHTML or the like via HTTP protocol communication, from the web server-capable fat client 10a and 11a to the request-issuing thin client 10b, 10c, . . . , 11b, 11c, and so forth. Alternatively, they are returned to the browser 12 of the fat client 10a and 11a itself in the form of DHTML or the like. The resulting information is presented on the customer display of the fat client 10a and 11a or thin client 10b, 10c, . . . , 11b, 11c, and so forth.

In the respective group of POS clients 10a, 10b, 10c, and so forth linked in series or POS clients 11a, 11b, 11c, and so forth linked in series, the fat clients 10a and 11a have the server functionality so that they accept requests based on events of the I/O devices 13 from the browser 12 of other thin clients 10b, 10c, . . . , 11b, 11c, and so forth, and the POS application 15 installed therein is activated in response thereto and returns its processing results to the request-issuing thin client 10b, 10c, and so forth or 11b, 11c, and so forth. The fat clients 10a and 11a themselves have their internal POS application 15, and are operable in standalone fashion so that the POS application 15 is activated in response to a request of their own browser 12, to which the processing result is returned. Furthermore, the fat clients 10a and 11a have a PLU file and performs product search in response to a request from the thin clients 10b, 10c, . . . , 11b, 11c, and so forth, thereby eliminating the need for providing the PLU file on the side of the thin clients 10b, 10c, . . . , 11b, 11c, and so forth.

As described above, because the POS server functionality is distributed between the groups of POS clients connected in series (i.e., concentration of the server functionality is avoided), even if the web server of either the fat client 10a or 11a goes down, the remaining fat client 11a or 10a will not be affected by the failed server, and the fat client 11a or 10a will act as a web server for the thin clients 11b, 11c, and so forth or 11b, 11c, and so forth connected in series thereto (i.e., prevent failure of the overall POS system).

In the above configuration, even when the database server 20 fails, only the afore-mentioned aggregation processing can no longer be performed, without bringing down the overall system.

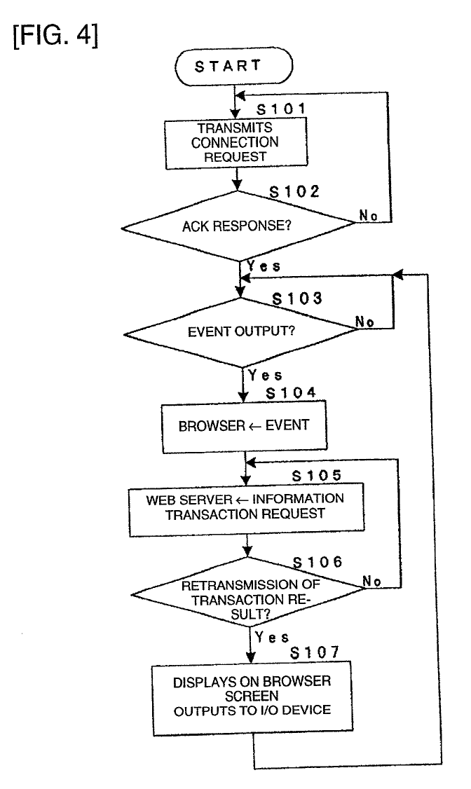

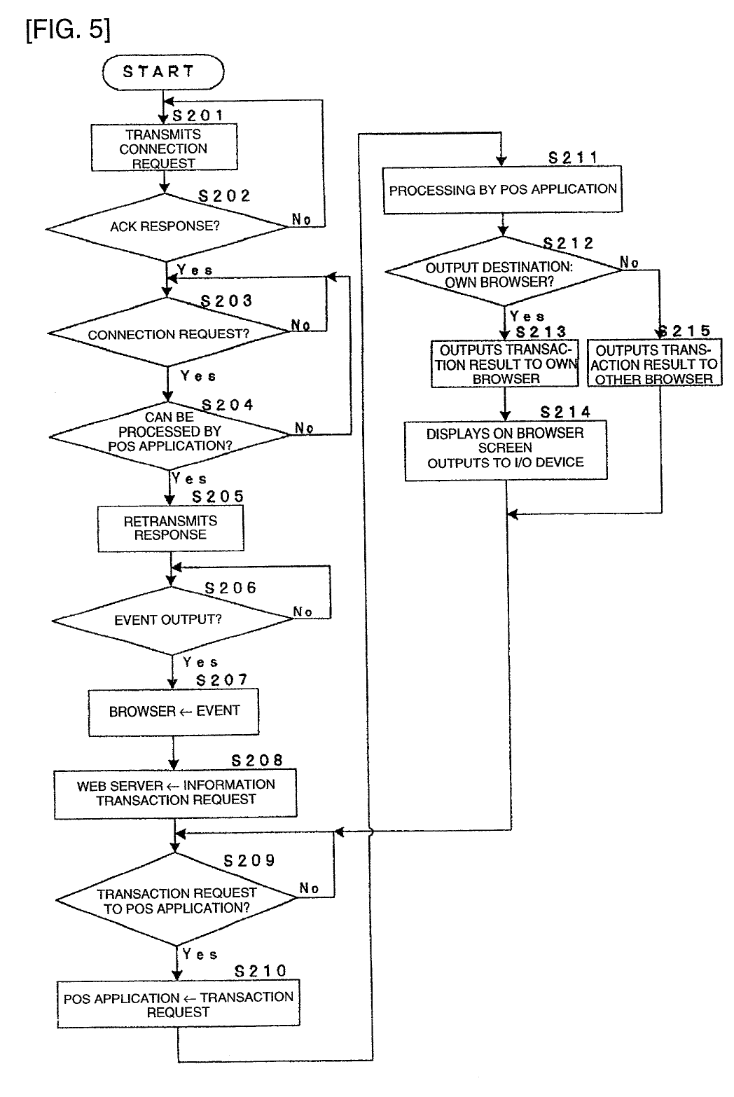

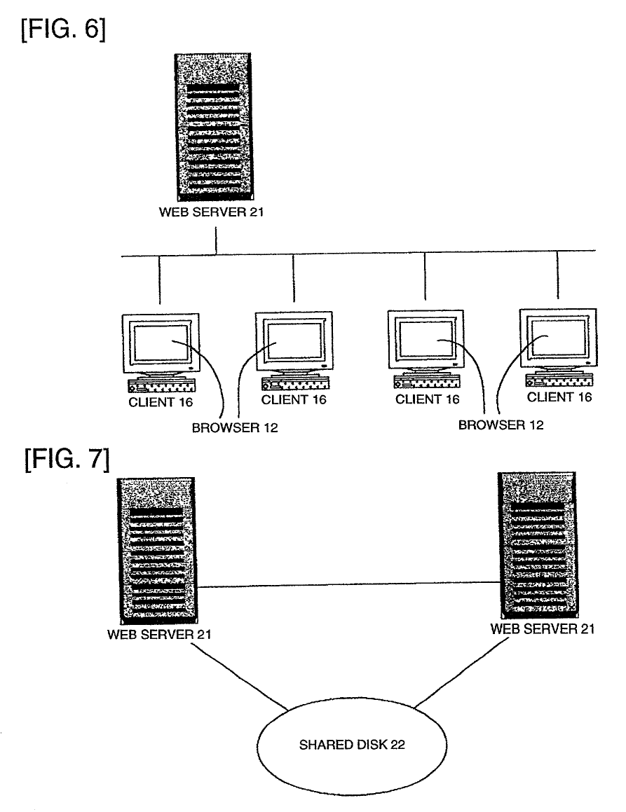

FIGS. 4 and 5 are flowcharts illustrating the process flow for the POS clients in the present POS system.

As shown in FIG. 4, the thin client 10b, 10c, and so forth or 11b, 11c and so forth connected to the fat client 10a or 11a issues a connection request to the server-capable fat client 10a or 11a connected to its own group when power is turned ON (step S101). Next, it checks whether there is an acknowledgment (ACK) response to that connection request from the fat client 10a or 11a (step 102). If not (step S102; No), the process returns to step S101.

On the other hand, if there is such a response (step S102; Yes), the thin client 10b, 10c, and so forth or thin client 11b, 11c, and so forth checks whether there is an event output from its own I/O device 13 (step S103). If so (step S103; Yes), that event is notified to the browser 12 via the O-POS 14 (step S104). If there is no event output (step S103; No), the process loops back to step S103 and repeats subsequently.

At step S104, at a time when there is an event input to the browser 12, the browser 12 sends an information processing request corresponding to that event to the web server of the fat client 10a or 11a (step S105).

Next, the thin client 10b, 10c, and so forth or 11b, 11c, and so forth checks whether there is any reply of the processing result from the web server of the fat client 10a or 11a corresponding to said request (step S106).

If there is a reply of the processing result (step S106; Yes), the content of the processing result is analyzed and displayed on the browser 12 screen or outputted to the I/O device 13, as needed (step S107), and then the process loops back to step S103. If there is no reply (step S106; No), the process loops back to step S105 and repeat the sequence subsequently.

FIG. 5 is a flowchart illustrating the process flow for the fat client 10a or 11a. As shown, the fat client 10a or 11a issues a connection request to the database server 20 connected via the LAN 30 when power is turned ON (step S201). Next, it checks whether there is an ACK response corresponding to this connection request from the database server 20 (step S202). If not (step S202; No), the process returns to step S201.

On the other hand, if there is an ACK response (step S202; Yes), the fat client 10a or 11a then checks whether there is a connection request from the thin client 10b, 10c, and so forth or 11b, 11c, and so forth (step S203). If so (step S203; Yes), its web server functionality checks whether the POS application 15 can accept the processing request, if any, and perform necessary processing (step 204); if so (step S204; Yes), it returns a response to the thin client 10b, 10c, and so forth or 11b, 11c, and so forth that issued the connection request (step S205). If not (step S204; No), the process loops back to step S203.

At step S203, if there is no connection request (step S203; No), the process loops back to step S203 and repeats the same sequence subsequently.

The fat client 10a or 11a then checks whether there is an event output from its own I/O device 13 (step S206). If there is an event output (step S206; Yes), that event is notified to the browser 12 via the O-POS 14 (step S207). If not (step S206; No), the process loops back to step S206 and repeats the same sequence subsequently.

At step S207, at a time when there is an event input to the browser 12, the browser 12 sends an information processing request corresponding to that event to the web server of the fat client 10a or 11a (step S208).

Next, it checks whether there is a processing request to the POS application 15 from the browser 12 installed in the thin client 10b, 10c, and so forth or 11b, 11c and so forth of its own group, including its own browser 12 (step S209). If so (step S209; Yes), that processing request is passed to the POS application 15 (step S210). The POS application then performs necessary processing, such as product registration (Price Look Up) (step S211). On the other hand, if there is not such a processing request (step S209; No), the process loops back to step S209 and repeat the same sequence subsequently.

After the processing by the POS application 15 is performed at step S211, it checks whether the output destination of the processing result is its own browser 12 (step S212). If so (step S212; Yes), the processing result is outputted to that browser 12 (step S213), which displays it on screen or outputs it to the I/O device 13 (step S214), and the process loops back to step S209. On the other hand, if the output destination is not its own browser 12 (step S212; No), the processing result is sent to the browser of the thin client 10b, 10c, and so forth or 11b, 11c, and so forth (step S215), and then the process similarly loops back to step S209.

It should be appreciated that the distributed processing system and clients of the present invention are not restricted only to the above embodiment but various modifications to the above embodiment may, of course, be made without departing from the scope and spirit of the present invention. For example, a POS server (prior art original POS server) that has a POS application 15, which is activated in response to a request issued from a POS client, and returns the processing result to the POS client that issued such a request may be connected to the LAN 30. In that case, however, it is preferable to give priorities to this server and the servers of the fat clients 10a and 11a so that said POS server normally works and if it fails, the fat client 10a and 11a may act as a server.

As described above, according to the implementation of the client/server system and clients of the present invention as set forth in claims 1 through 6, there can be provided a significant benefit in that failure of the overall system due to failure of the server can be prevented without using complex and expensive server clustering technology. Especially, when the present invention is applied to a system that employs disk-less thin clients, a system configuration that offers such a benefit can be achieved (in terms of cost and other factors).

What is claimed is:

1. A distributed processing system comprising a plurality of clients linked in series, wherein at least one of said clients is operable in standalone fashion and has server functionality so that it executes processing in response to requests issued by other clients and outputs the results of the processing to said clients that issued such requests.

2. The distributed processing system according to claim 1, wherein processing of a POS application in a POS client having the server functionality includes at least one of the following: product registration, product search, transaction aggregation per transaction, tax aggregation per transaction, discount per target product, designation of payment method, settlement, transaction history registration, and operator authentication and registration.

3. A plurality of clients linked in series, wherein at least one of said clients is operable in standalone fashion and has server functionality so that it executes processing in response to requests issued by other clients and outputs the results of the processing to said clients that issued such requests.

4. The clients according to claim 3, wherein processing of a POS application in a POS client having the server functionality includes at least one of the following: product registration, product search, transaction aggregation per transaction, tax aggregation per transaction, discount per target product, designation of payment method, settlement, transaction history registration, and operator authentication and registration.
